(19) United States
(12) Patent Application Publication
(10) Pub. No.: US 2013/0247770 A1
(43) Pub. Date: Sep. 26, 2013

(54) BEVERAGE DISPENSING SYSTEM

(71) Applicants: Haim Wilder, Raanana (IL); Eyal Krystal, Kfar Saba (IL); Omri Bar-On, Jerusalem (IL)

(72) Inventors: Haim Wilder, Raanana (IL); Eyal Krystal, Kfar Saba (IL); Omri Bar-On, Jerusalem (IL)

(73) Assignee: STRAUSS WATER LTD., Petach Tikva (IL)

(21) Appl. No.: 13/991,601

(22) PCT Filed: Feb. 15, 2012
(86) PCT No.: PCT/IL12/50047

§ 371 Date: Jun. 4, 2013

Related U.S. Application Data
(60) Provisional application No. 61/447,441, filed on Feb. 28, 2011.

(51) Int. Cl. A47J 31/46

(52) U.S. Cl. CPC A47J 31/46
USPC 99/281; 99/300

(57) ABSTRACT

This invention relates to a dispensing system, comprising a dispensing outlet (108) for dispensing beverage at a controlled temperature, a mixing chamber (120) upstream in a flow path to said outlet such that dispensed beverage flows from said chamber to the outlet, at least three feeding lines (124, 126, 128) feeding beverage of at least three different defined temperatures to said chamber; and a controller (500) for controlling the feed from each of said feeding lines so as to yield a desired temperature of the dispensed beverage.

### REFERENCE TO RELATED APPLICATIONS

This application is a national stage application under 35 USC 371 of International Application No. PCT/IL2012/050047, filed Feb. 15, 2012, which claims the priority of Provisional Application No. 61/447,441, filed Feb. 28, 2011, the entire contents of which are incorporated herein by reference.

### FIELD OF THE INVENTION

This invention relates to a dispensing system for a beverage, particularly drinking water that allows adjustment of the temperature of the dispensed liquid to achieve a desired temperature.

### BACKGROUND OF THE INVENTION

Systems for dispensing beverages at different temperatures are known, and especially for dispensing of water for household uses.

For example, Chinese utility model application CN201365830 discloses a double-container double-control water dispenser, having a water boiling tank and a water storage tank, water level controlling switches, electrically controlled temperature controller, and water inlet and outlet pipes, which are arranged as to avoid the blending of boiled water and unboiled water.

UK Patent GB2143031 describes a hot water dispenser, having a separate hot water container with a heater and a cold water container. The containers are interconnected, such that when hot water is drawn from a tap, cold water is fed from the cold water container through a tube to a point adjacent the bottom of the hot water container so that the hot water to be dispensed is kept at or near the correct dispensing temperature.

Further examples are disclosed in patent publications U.S. Pat. No. 5,858,437, U.S. Pat. No. 6,609,391, US 2004/011814, and U.S. Pat. No. 6,871,675.

### SUMMARY OF THE INVENTION

The present invention provides a dispensing system for a beverage that permit adjustment of the temperature of the dispensed liquid to a desired temperature including, by a specific embodiment, cooled liquid, heated liquid, liquid at ambient (“room”) temperature and a range of temperatures in between.

This is achieved, in accordance with the invention, by feeding a beverage dispensing outlet with beverage at different temperatures and adjusting the flow of liquid of each temperature so as to achieve a desired temperature of the dispensed beverage.

In accordance with a first aspect of the invention, there is provided a system for dispensing a beverage including, but not limited to water. The system comprises a dispensing outlet for dispensing beverage at a controlled temperature, a mixing chamber upstream in a flow-path to said outlet, such that the dispensed beverage flows from said chamber to said outlet, and at least three feeding lines that feed beverage of at least three different defined temperatures to said chamber. The system also comprises a controller that controls the feed from each of the feeding lines so as to achieve, through proper mixing of the beverage of different temperatures, a desired temperature of the dispensed beverage. Typically, the system includes also a user interface that permits a user to set the temperature of the dispensed beverage to a desired temperature. Once set, upon activation of the system so as to dispense beverage, the flow rate in each of the feeding lines is adjusted to achieve the desired, set temperature.

The invention also provides by another of its aspects, a process for dispensing a beverage at a desired temperature. The process comprises providing a source for beverage of at least three different defined temperatures and separately feeding a beverage from one or more of these sources to a dispensing outlet, the amount of liquid fed from each feeding line being adjusted to achieve the desired temperature.

In accordance with the invention, the beverage fed by one or more of the feeding lines is mixed within the mixing chamber and this ensures that the dispensed beverage will have the desired temperature as set by the user. By one embodiment, the outlet is integrally formed at the bottom of the chamber. However, other arrangements are also contemplated within the scope of the present invention.

In accordance with an embodiment of the invention the chamber includes dividers that divide the chamber into a plurality of sub-chambers. Typically, each sub-chamber is fed beverage by a different feeding line. The arrangement is typically such that each of these sub-chambers opens to a single dispensing outlet of the mixing chamber, which is mutual to all sub-chambers and which, in accordance with one embodiment, is the beverage dispensing outlet of the system.

The system of the invention typically, although not exclusively, comprises a feeding line for a heated beverage, a feeding line for beverage at ambient temperature and a feeding line for cooled beverage. In accordance with this embodiment each feeding line feeds beverage at its specific temperature to the mixing chamber and therefrom to the dispensing outlet and the amount of liquid fed from each line is adjusted to achieve the desired temperature. In the specific embodiment of such three defined temperatures, the temperature of the dispensed beverage may be adjusted to dispense heated beverage, cooled beverage or in a range of temperatures in between according to the system's temperature accuracy and taking into account the temperature drop or rise in the beverage as it flows through the feeding lines. In the specific embodiment whereby the beverage is drinking water, the dispensed liquid can be used to prepare a hot beverage such as coffee or tea, may be used to dispense chilled water, water at room temperature, etc. By an example, the heated beverage may be at a temperature in the range of 90-98° C. and the cooled beverage may be at a temperature range of 2-10° C.

In accordance with one embodiment of the invention, the system includes a heated beverage reservoir, typically a chamber formed at the top of a beverage heating unit. In accordance with another embodiment of the invention, the system includes a cooled beverage reservoir. Typically, the system includes also a cooling unit and the beverage flows through the cooling unit, cooled thereby, and then into the cooled beverage reservoir.

In accordance with an embodiment of the invention, the system includes also a reservoir for a beverage at ambient (“room”) temperature. Typically, where the beverage is water, this reservoir stores filtered or purified water. By an embodiment of the invention, the heated beverage reservoir and the cold beverage reservoir are fed beverage from the reservoir that stores beverage at ambient temperature.

In accordance with an embodiment of the invention, one or more pumps for propelling a beverage through said one or more feeding lines may be included in the system for propelling beverage towards the mixing chamber.

By one embodiment, the system comprises a first pump for propelling heated beverage through the heated beverage feeding line, a second pump for propelling beverage through the ambient temperature beverage feeding line, a third pump for propelling beverage from the ambient temperature reservoir to the cooled beverage reservoir through a liquid cooling unit, and a fourth pump for propelling beverage from the cooled beverage reservoir through the cooled beverage feeding line. The third pump is typically activated automatically to fill the cooled beverage reservoir. For this purpose, the cooled beverage reservoir may include a liquid level sensor that through a closed-circuit control activates the third pump upon emptying of this reservoir. Against this, the first, second and fourth pumps, are automatically activated during liquid dispensing and their pumping rates are adjusted so as to achieve a desired dispensed beverage temperature. The user typically sets a desired temperature for the dispensed beverage, and can then press a certain dispensing activation button or switch, whereupon the respective first, second and fourth pumps are activated to yield a beverage at the desired temperature as set by the user.

In accordance with another embodiment of the invention, a single pump provides a propelling force for more than one feeding line. Typically, in accordance with this embodiment, such a pump's outlet is linked, through a manifold, to more than one beverage feeding line whereupon the flow rate in each of such feeding lines is then controlled by valves or other flow controlling elements fitted on the individual feeding lines. In accordance with this embodiment, the beverage propelled by the pump may then be heated or cooled to a certain fixed temperature by appropriate elements fitted on the different feeding lines. By one example, such a centralized pump is in flow communication with an outlet of an ambient temperature beverage reservoir and being configured to draw beverage from the reservoir and propel it, through a manifold system, to each of three feeding lines: an ambient temperature feeding line, a hot beverage feeding line which includes a heating arrangement for heating the beverage channeled into this line, and a cooled beverage feeding line which includes a cooling element for cooling the beverage channeled therethrough. While, by one embodiment, the cooled beverage feeding line may include an inline cooling system that cools the beverage as it flows through this feeding line on its way to the dispensing outlet, in accordance with one embodiment a cooled liquid reservoir is included and the beverage, cooled by the cooling element, is stored within the cooled beverage reservoir and can be drawn therefrom on demand. In accordance with this embodiment, an auxiliary pump is provided that is configured for drawing liquid from the cooled beverage reservoir and propelling it to the mixing chamber.

Also provided, by another aspect of the invention, is a beverage dispenser, particularly a dispenser for drinking water that comprises a system of the kind defined and disclosed herein.

As will be appreciated by the reader, an advantage of the invention is the fact that the temperature of the dispensed beverage is not limited to certain discreet values, typically pre-set through the system's characteristics as in existing beverage dispensers, but rather the user has a large flexibility for setting the temperature according to his liking and need. Also, unlike beverage dispensers that dispense beverage at different temperatures from different dispensing outlets, including for example a hot beverage outlet and a cooled beverage outlet, in accordance with the invention there is a single outlet that dispenses beverage at a desired temperature.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a perspective view of a water dispenser which includes a water dispensing system in, accordance with an embodiment of the invention.

FIGS. 2A-2D are, respectively, a bottom view, side view, horizontal cross-sectional view along line 2C-2C in FIG. 2B and a vertical cross-sectional view through line 2D-2D in FIG. 2A, of a mixing chamber with its integral dispensing outlet, according to an embodiment of the invention.

FIGS. 3A and 3B are schematic illustrations of two embodiments of a flow system in accordance with the invention.

FIG. 3C is a schematic illustration of the control unit according to an embodiment of the invention.

FIGS. 4A-4D show, respectively, front view, left side view, right side view and rear view of the water flow system elements of the dispenser of FIG. 1.

### DETAILED DESCRIPTION OF EMBODIMENTS

In the following description the invention will be illustrated with reference to a water dispenser, namely a dispenser and system where the beverage is water. Accordingly, reference in the description below will be made to “water reservoir”, “hot water feeding line”, “cold water feeding line”, etc. It should be noted, however, that the specific reference which is made to a water dispenser is intended for purposes of illustration and is not intended to be limiting in any way. Rather, the general teaching of the invention may be applicable, at times with some modifications, for different kinds of beverages, for example, for milk, flavored beverages, etc.

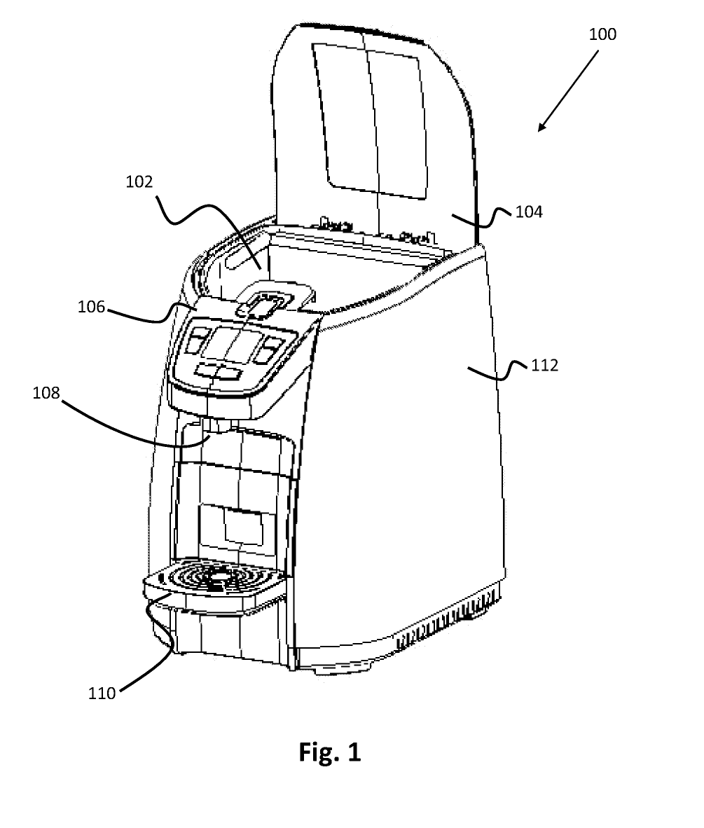

Reference is first being made to FIG. 1 showing a water dispenser 100, typically designed for home use, which includes a water container 102, a hinged lid 104 that covers the container, a user accessible control consul 106, a water dispensing outlet 108, a tray element 110 and a housing 112. This water dispenser includes a water filtration system which is disclosed and claimed in PCT Application Serial No. PCT/IL2012/050038. Briefly, without going into details, source water, typically tap water, is introduced into a container 102 and is then filtered through the system and collected in an ambient temperature water reservoir, that will be described below.

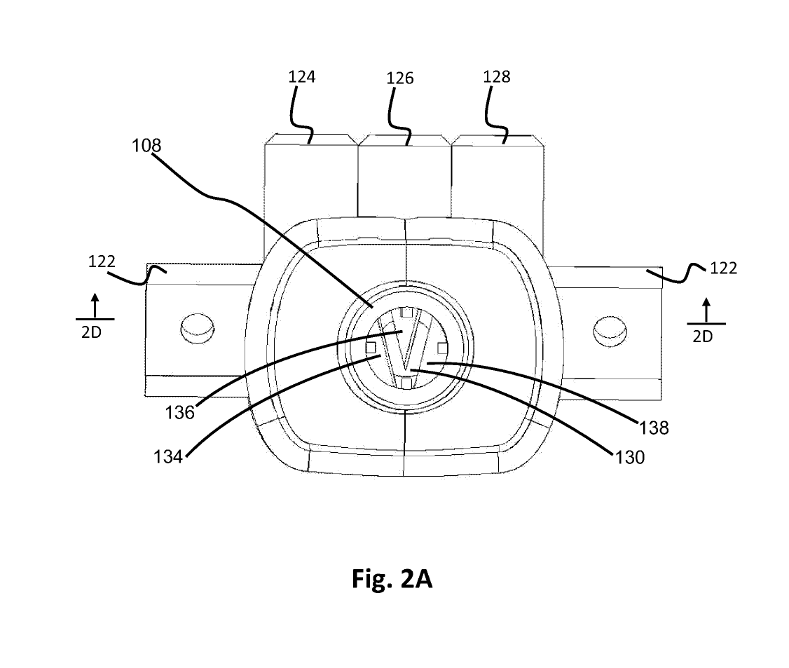

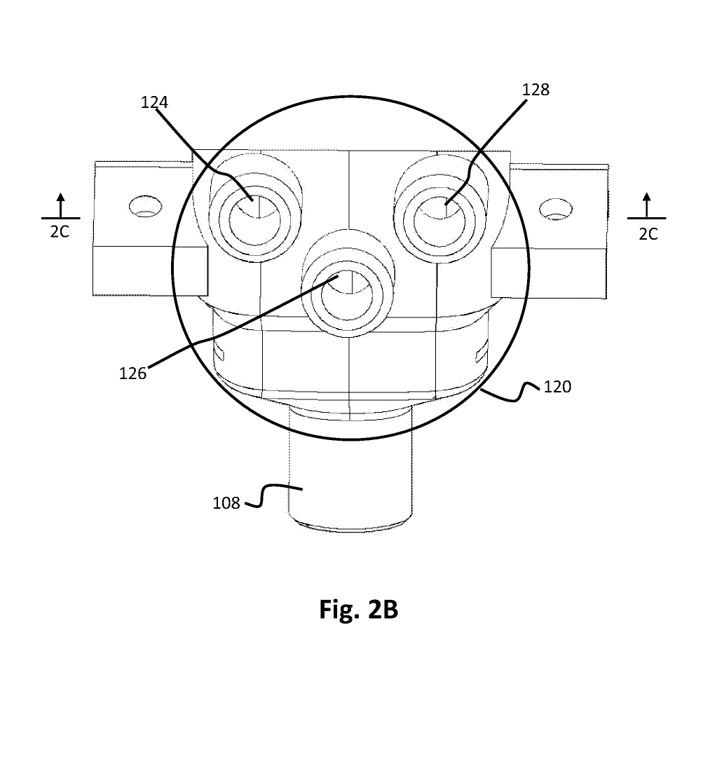

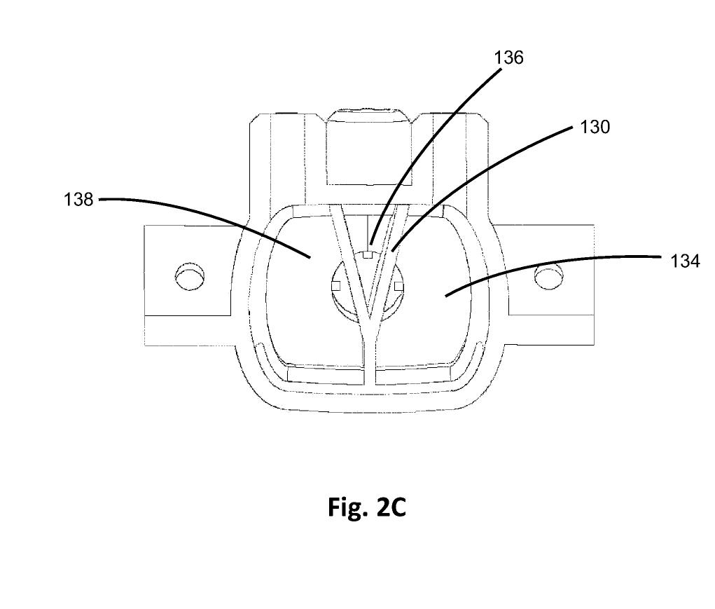

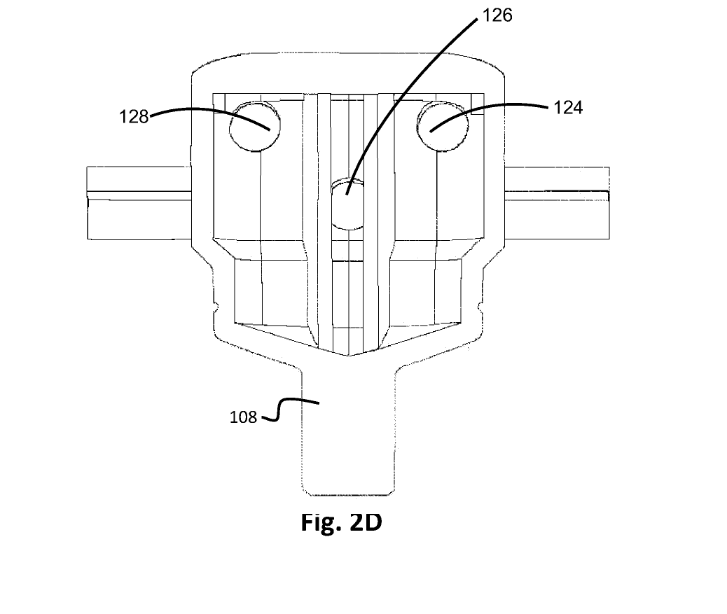

Reference is now being made to FIGS. 2A to 2D showing a mixing chamber 120 which is integrally formed with the water dispensing outlet 108. The mixing chamber is fitted with two side lugs 122 which serve to fix it to the device. The chamber includes three water inlets 124-128, each of which is connected to one of three feeding lines—a cooled water feeding line, an ambient temperature water feeding line, and a heated water feeding line, respectively.

The mixing chamber is fitted with a “Y”-shaped divider 130 which divides the mixing chamber into three sub-chambers 134, 136 and 138, each of which opening to one of the inlets 124, 126 and 128 and thereby receive the respective fed water from these inlets. The sub-chambers are drained into the mutual water dispensing outlet 108 and at the outlet the water coming from the different feeding lines is thus mixed to achieve a desired, set temperature, as will be further illustrated below.

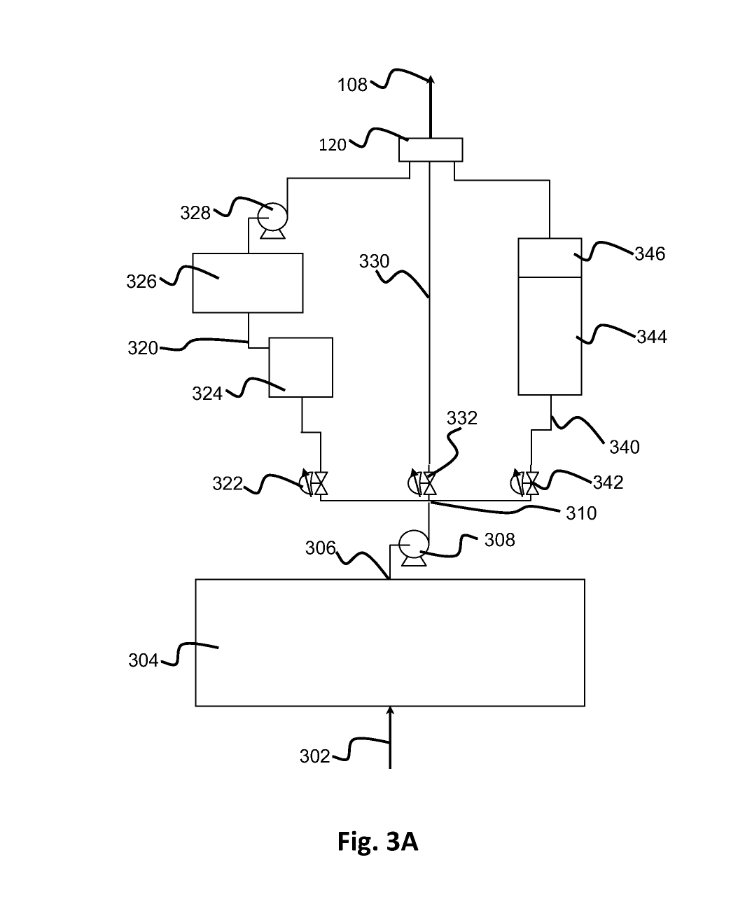

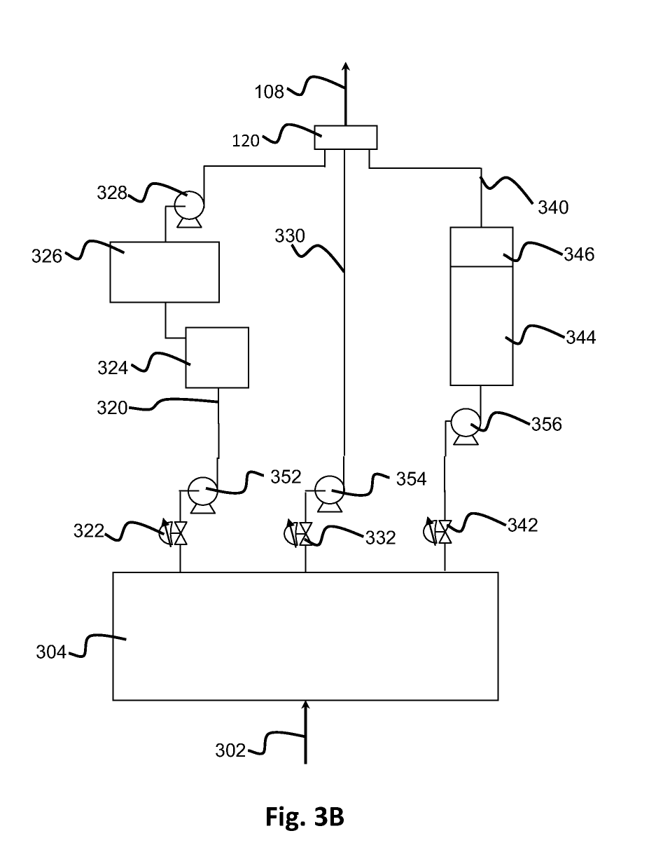

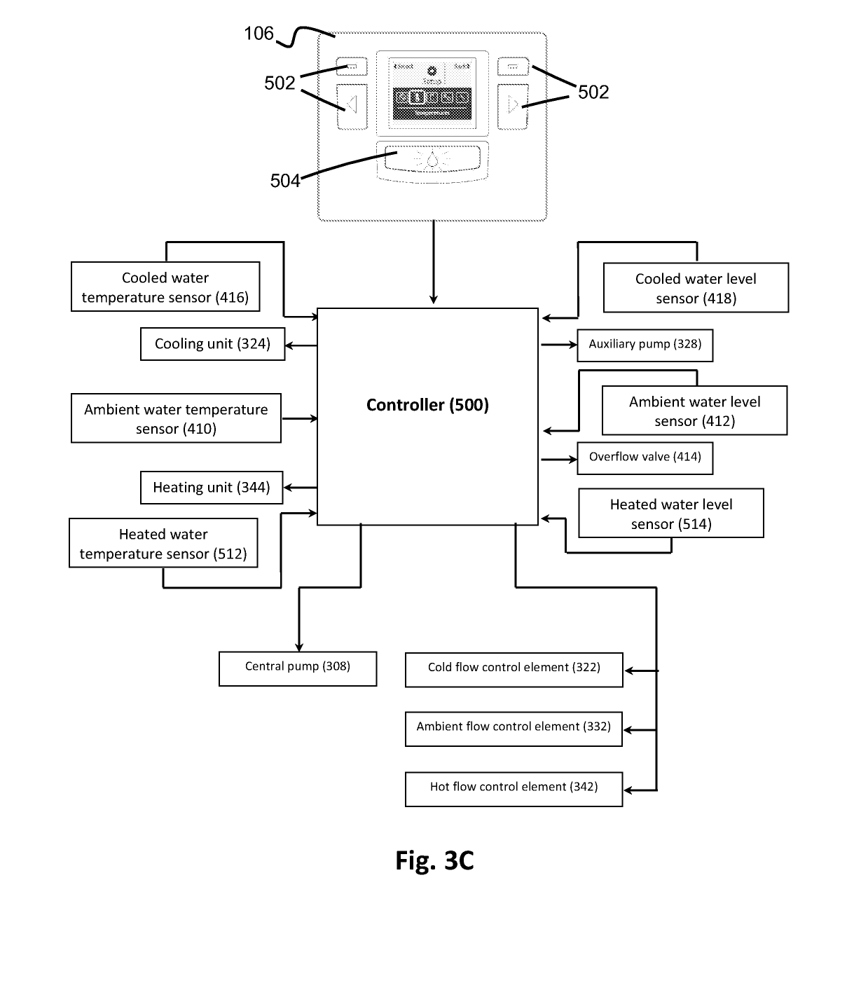

The embodiments illustrated schematically in FIGS. 3A and 3B, show two possible configurations of the system of the invention. In each of these configurations, the system includes three flow lines: a cooled water flow line, an ambient temperature water flow line, and a heated water flow line. Referring first to FIG. 3A, water, typically filtered water is fed through 302 into an ambient temperature water reservoir 304. Fitted at the outlet 306 of reservoir 304 is a pump 308 that propels the water into the feeding lines as will be described below.

Included are three feeding lines including cooled water feed line 320, ambient temperature feeding line 330, and heated water feeding line 340. Fitted in each feeding line are respective valving or flow control arrangements 322, 332 and 342, linked to the pump through a manifold arrangement 310. Through control of valves or flow regulators 322, 332 and 342, the rate of flow in each of the respective feeding lines is controlled.

The cooled water feeding line includes a cooling unit 324, which may, for example, be a Peltier-based unit of the kind disclosed in WO2011/030339, the relevant content of which being incorporated herein by reference. Cooled water is then collected and stored in cooled water reservoirs 326. Pump 308 and valving arrangement 322 cooperate so as to continuously fill reservoir 326 with cooling water. The cooled water reservoir 326 as well as the ambient temperature water reservoir 304 may be fitted with a water level indicator of the kind disclosed in PCT Application Serial No. PCT/IL2011/050085.

Feeding line 320 includes also a pump 328 which is configured to draw cooled water from reservoir 326 and feed it into mixing chamber 120 which is linked to dispensing outlet 108.

Hot water feeding line includes a heating unit 344 and a hot water reservoir 346, typically forming part of the heating unit. A heating unit of this kind is disclosed in PCT publication no. WO2011/114327.

Thus, by this configuration, the pump 308 provides the driving force that propels liquid from reservoir 304 to mixing chamber 120, and from there to dispensing outlet 108 while flow regulators 322, 332 and 342 regulate their relative flow in each of its respective feeding lines to achieve a certain desired temperature as set by the user. An example of such a regulator is a proportional electric valve, although the invention is not limited thereto.

An embodiment with an alternative configuration is shown in FIG. 3B. Components having the same function as those of FIG. 3A have been given like reference numerals and the reader is referred to the description of these components above to understand their function.

The main difference is that in this embodiment, rather than controlling flow in the three flow systems through a flow regulator, each of the flow systems 320, 330 and 340 is provided with its own respective pump, 352, 354 and 356. Each of the pumps is linked to reservoir 304, either directly as shown schematically in FIG. 3B, or, alternatively, through a manifold arrangement linked to a single outlet of the reservoir.

A control unit operable in a system in accordance with an embodiment of the invention, of the kind illustrated in Fig. A, is shown in FIG. 3C. A controller 500 is linked to a control consul 106 which includes an actuation button or switch 504 that permits a user to activate the water dispensing action and a temperature control module 502 permitting the user to set a desired temperature for the dispensed water. The controller is linked and is operable to activate the central pump 308, to induce dispensing of water out of the dispensing outlet. The controller is also linked to a variety of sensing elements, including temperature sensors 410, 416 and 512, water levels sensors 412, 418 and 514 and is also operable to activate the three flow control elements 322, 332 and 342 as well as auxiliary pump 328. In addition, the controller is also operable to control the activity of the cooling unit 324 and the heating unit 344 as well as the overflow valve 414.

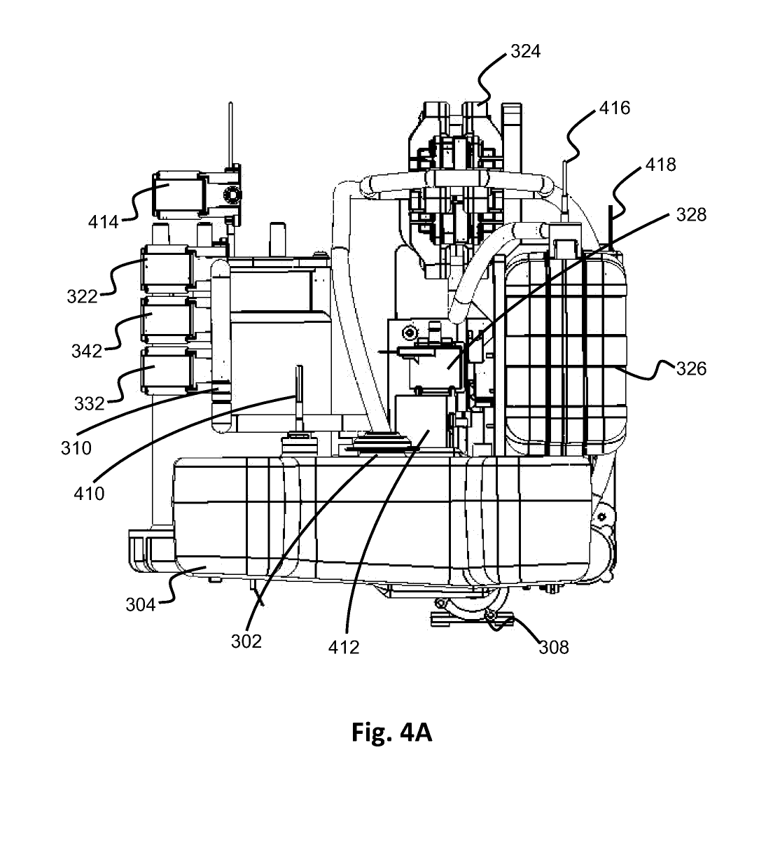

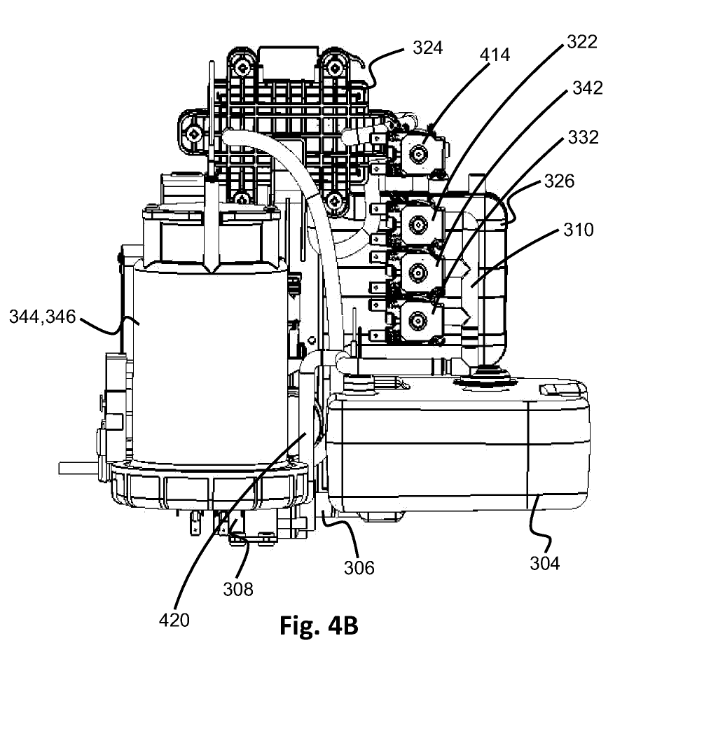

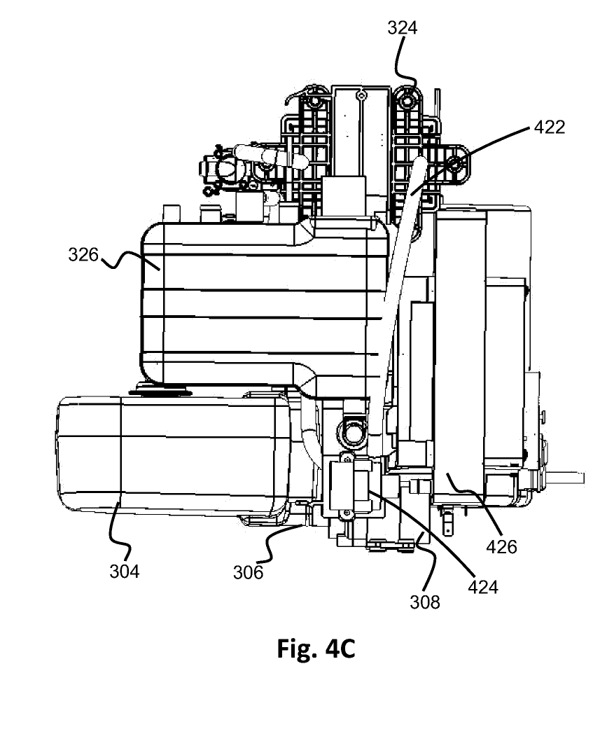

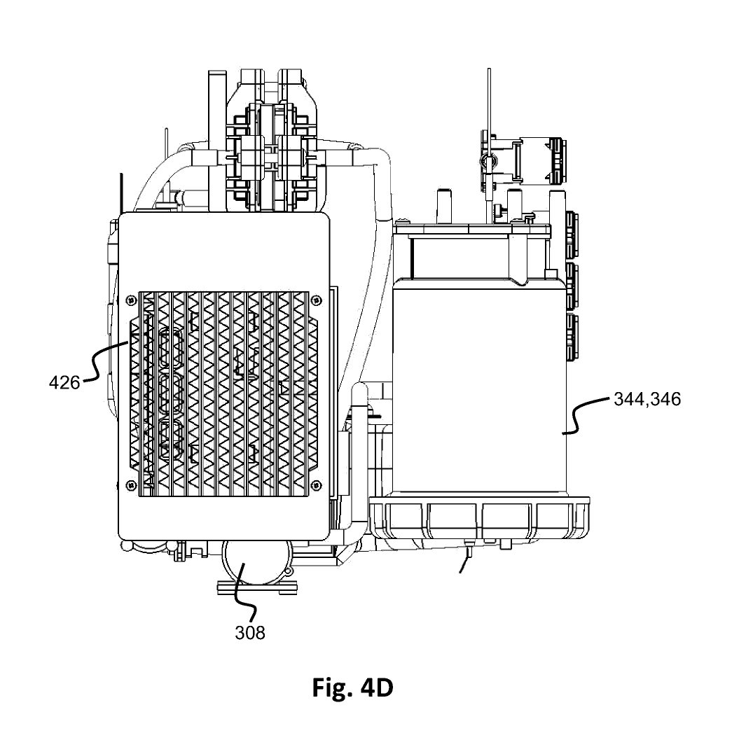

Reference is now being made to FIGS. 4A-4D, which show a system of the invention having a configuration of the kind shown schematically in FIG. 3A. Accordingly, like reference numerals were used in FIGS. 4A-4D to relate to components having the same function as those of FIG. 3A.

As can be seen particularly in FIGS. 4A-4C, fitted at the bottom of the system is an ambient temperature water reservoir 304, having an inlet 302, which is linked to a water filtration system, not shown, and which is disclosed in the aforementioned PCT Application PCT/IL2012/050038. Reservoir 304 has a temperature sensor 410 and has an associated water level sensor 412, the latter being linked to the filtration system to ensure filling of a reservoir and avoid overfilling. This is achieved through control of flow regulator 414, in a manner as described in aforementioned PCT Application Serial No. PCT/1L2011/050085.

Linked to outlet 306 of reservoir 304, is a pump 308 which is linked through tubing 420 to a manifold arrangement 310 feeding water to flow control elements 322, 332 and 342, fitted on the cooled water feeding line, the ambient temperature water feeding line, and the heated water feeding line, respectively.

In the cooled water feeding line, water flows from flow regulator 322 to the Peltier-based cooling unit, configured in accordance with the disclosure in WO2011/030339, the content of which is incorporated herein by reference. Other elements of the cooling arrangement include radiator 426 and pump 424, for circulating a heat absorbing liquid from element 324 to radiator 426 for hit dissipation through tubing 422.

Water cooled by cooling element 324 is then collected in cooled water reservoir 326 having an associated temperature sensor 416 and a water level indicator 418 of the kind noted below. The cooled water feeding line includes also a pump 328 which draws cooled water out of reservoir 326 and feeds it to the mixing chamber 120.

Heated water feeding line includes a heating element 344 and an associated heated water reservoir 346, of the kind noted below.

1. A beverage dispensing system, comprising:
a dispensing outlet for dispensing beverage at a controlled temperature;
a mixing chamber upstream in a flow path to said outlet such that dispensed beverage flows from said chamber to the outlet;
at least three feeding lines feeding beverage of at least three different defined temperatures to said chamber; and
a controller for controlling the feed from each of said feeding lines so as to yield a desired temperature of the dispensed beverage.

2. The dispensing system of claim 1, wherein said outlet is integrally formed at the bottom of said chamber.

3. The dispensing system of claim 1, wherein said chamber includes dividers dividing it into a plurality of sub-chambers.

4. The dispensing system of claim 3, wherein each sub-chamber is fed beverage by a different feeding line.

5. The dispensing system of claim 1, comprising a feeding line for heated beverage, a feeding line for beverage at ambient temperature and a feeding line for cooled beverage.

6. The dispensing system of claim 1, comprising a heated beverage reservoir in flow communication with a heated beverage feeding line, an ambient temperature beverage reservoir in flow communication with an ambient temperature beverage feeding line, and a cooled beverage reservoir in flow communication with a cooled beverage feeding line.

7. The dispensing system of claim 6, wherein the heated beverage reservoir and the cooled beverage reservoir are fed liquid from the ambient temperature beverage reservoir.

8. The dispensing system of claim 1, wherein one or more of the feed lines comprises a pump for propelling beverage therethrough towards the chamber.

9. The dispensing system of claim 6, comprising a first pump for propelling heated beverage through the heated beverage feeding line, a second pump for propelling beverage through the ambient temperature beverage feeding line, a third pump for propelling beverage from the ambient temperature reservoir to the cooled beverage reservoir through a liquid cooling unit and a fourth pump for propelling beverage from the cooled beverage reservoir through the cooled beverage feeding line.

10. The dispensing system of claim 9, wherein the third pump is activated automatically to fill the cooled beverage reservoir; the first, second and fourth pump being automatically activated only during liquid dispensing, and their pumping rates being adjusted so as to achieve a desired dispensed beverage temperature.

11. The dispensing system of claim 8, wherein a said pump's outlet is linked through a manifold, to more than one feeding lines selected from the group consisting of a heated beverage feeding line, an ambient temperature beverage feeding line, and a cooled beverage feeding line, the flow rate in each of such more than one feeding lines is controlled by flow control elements fitted on the individual feeding lines.

12. The dispensing system of claim 8, comprising an ambient temperature feeding line, a hot beverage feeding line which includes a heating arrangement for heating the beverage flowing therethrough, and a cooled beverage feeding line which includes a cooling element for cooling the beverage flowing therethrough; said pump being in flow communication with an outlet of an ambient temperature beverage reservoir and being configured to draw beverage therefrom and propel it, through a manifold system, to each of three feeding lines.

13. The dispensing system of claim 6, wherein the cooled beverage feeding line comprises a cooled beverage reservoir.

14. The dispensing system of claim 6, comprising an auxiliary pump configured for drawing liquid from the cooled beverage reservoir and propelling it to the mixing chamber.

15. The dispensing system of claim 1, comprising temperature sensors for measuring temperature at each of the feeding lines.

16. The dispensing system of claim 1, comprising a user interface permitting a user to input the desired temperature of the dispensed beverage.

17. A water dispenser comprising the system of claim 1.

18. The water dispenser of claim 17 comprising water filtration system.

19-30. (canceled)
